(19) United States
(12) Patent Application Publication
(10) Pub. No.: US 2005/0051970 A1
(43) Pub. Date: Mar. 10, 2005

(54) Piston ring

(76) Inventor: Wolfgang Edelmann, Vienna (AT)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 10/937,733

(22) Filed: Sep. 10, 2004

(30) Foreign Application Priority Data
Sep. 10, 2003 (AT) A 1426/2003

(51) Int. Cl. F16J 15/16

(52) U.S. Cl. 277/435

(57) ABSTRACT

A twin piston ring includes of two concentric rings (1, 2) whereby the first ring (1) is designed as an L-shaped ring and the second ring (2) is designed as an inserted cross sectioned ring with a gap (6) that is offset relative to the one of the first ring (1). The inserted ring (2) is arranged on the pressure side (12) of the piston ring to ensure uniform wear of both rings (1, 2) at unchanging good sealing effect and to ensure simple manufacturing whereby, in addition, the inserted second ring (2) is provided with a projection (18) overlapping the gap (5) of the L-shaped ring (1) at the pressure side (12, 15) as well as the inner side (16) near the axis, and whereby the projection (18) forms at the same time a locking device against twisting of the rings (1, 2) against one another.

### BACKGROUND OF THE INVENTION

1. Field of the Invention

The invention relates to a piston ring, particularly for a reciprocating piston compressor for specific light gases, consisting of two concentric rings having at least one gap each whereby the first ring has a first arm with an essentially L-shaped cross section extending inwardly in the direction of the axis and a second arm perpendicular thereto extending outwardly, and whereby the second ring has a cross section fitting the missing section in the essentially L-shaped cross section in the form of a rectangular or square recess into which the first ring is inserted opposite of its gap edge(s), which is (are) rotated in circumferential direction or which is (are) disposed opposite the off-set gap edge(s) while sealing the clearance between the piston and the cylinder.

2. The Prior Art

Such components, which are also known as twin piston rings, have been disclosed for some time (i.e. in GB 1 222 609) and they are used specifically in the compression of very light gases to a very high ultimate pressure, such as hydrogen, for example. Sealing elements with a very high sealing effect are employed thereby to keep leakage as low as possible whereby the sealing effect can be achieved in an advantageous manner with such twin piston rings through the above-described fitting of the rings into one another so that there are no through-going gaps. Especially in case of dry-running, self-lubricating plastic synthetic rings, the occurring irregular wearing of the two rings represents, nevertheless, a problem since the two rings do no longer fully overlap one another and gaps develop through which a large amount of leaking gas can flow, particularly in case of very light gases under high pressure, which considerably decreases the flow rate of dry-running compressors sealed in such manner. It is furthermore of a disadvantage thereby that the cross sectioned ring used on the sealed side is extruded in the gap produced structurally between the piston and the cylinder.

It is known from WO 97/19280 A1 or EP 1 275 888 A1 to counter the above-mentioned problem, to design the bearing surface of the two rings of the twin piston rings in such a manner that the two rings are coupled in radial direction by positive fit so that uniform wear of the two rings occurs during operation and whereby development of leakage between the rings is prevented in the best possible manner. However, a disadvantage in this design of twin piston rings are the relatively complicated form of the essentially radial oriented bearing surface between the two rings and the problems with sealing and service life caused in this area again by particle accumulation and wear.

It is the object of the present invention to improve a twin piston ring of the aforementioned type in such a manner that the cited disadvantages of the disclosed type of arrangement are avoided and that there can be ensured in a simple and operationally reliable way the uniform wear of both rings while maintaining an unchanging good sealing effect even with specific light gases and high ultimate pressures.

### SUMMARY OF THE INVENTION

This object is achieved according to the present invention with a piston ring of the aforementioned type in that the second ring is fitted into the L-shaped cross section of the first ring at the pressure side and whereby the second ring is provided with a projection overlapping the associated gap of the first ring at the pressure side as well as the groove manufactured into the first ring at the inner side near the axis.

The invention is thereby based on the known use of twin piston rings of the aforementioned type and known from GB 1 222 609, for example, in which such rings are used as throttle rings whereby the inserted ring is disposed at the pressure side (the entire twin piston ring is thus inserted in an inverted, offset manner.) Nevertheless, there is created a leakage in the region of the impact point of the L-shaped ring, which is desirable in this case, through which leakage a controlled pressure release or a controlled distribution of increasing pressure is made possible onto all rings with the use of a corresponding amount of such throttle rings arranged one behind the other. The described projection is now formed on the inserted ring facing the pressure side to eliminate this leakage, which is not desired in the present case of usage, whereby the projection overlaps the gap of the first ring at the pressure side and also at the inner side, and whereby the cited problems of such twin piston rings are eliminated in a simple manner. The cooperating surfaces of the two rings are still designed in a simple manner and they can be easily manufactured thereby, which decreases manufacturing costs and ensures a long service life and an unchanging good sealing effect or an unchanging low degree of leakage.

In an especially preferred additional embodiment of the invention it is proposed that the second ring is provided with pressure compensation grooves on its contact surfaces facing the first ring. The inventive twin piston ring operates under a pressure load in such a manner that the first split ring, which is L-shaped cross section, drags along the inserted second ring whereby both rings wear in a uniform manner. The second ring is “pressure compensated” through the pressure compensation grooves on said second ring whereby friction and wear is generally minimized relative to the ring-width ratio.

According to an additional preferred embodiment of the invention, essentially radial oriented pressure relief grooves can be arranged on the face of both rings at the pressure side to change the normal “double action” twin piston ring of the invention into a “single action” twin piston ring whereby the captured pressure is relieved during the change in pressure.

According to an additional preferred embodiment of the invention, a pressure compensation bore can be arranged in the region of the projection of the second ring to prevent irregular wear in this region.

The invention is described in the following in more detail with the aid of drawings of embodiment examples illustrated partially schematically.

### DETAILED DESCRIPTION OF THE DRAWINGS

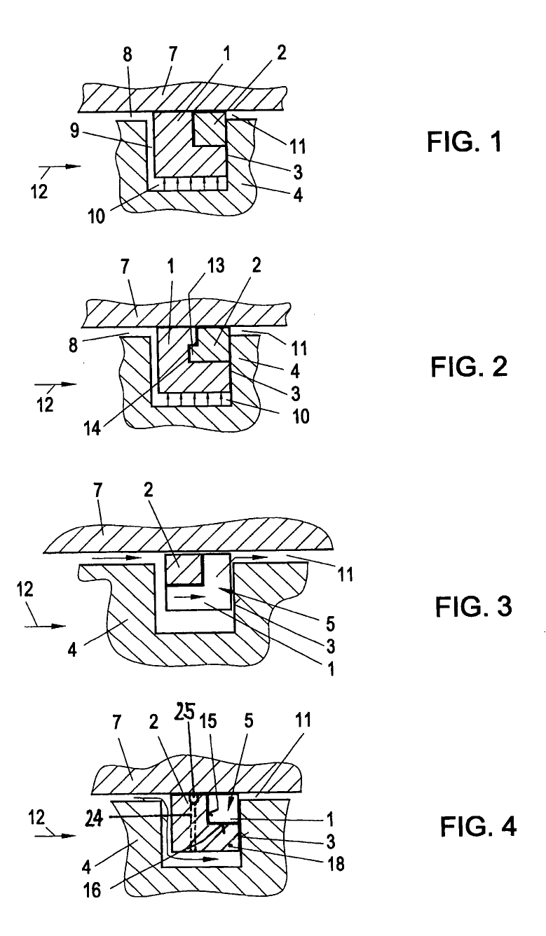

FIGS. 1 and 2 show thereby schematic cross sections of installed twin piston rings according to the prior art;

FIG. 3 shows a schematic cross section through an installed twin piston ring according to FIG. 1 in a known use as a throttle ring;

FIG. 4 shows essentially a cross section corresponding to FIG. 3 through a twin piston ring of the invention;

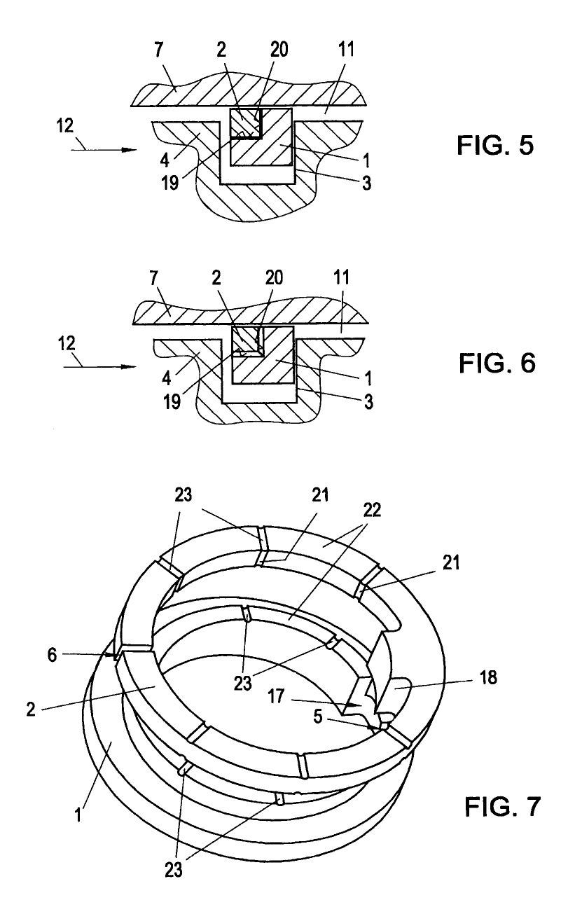

FIGS. 5 and 6 show the piston ring of FIG. 4 according to the invention, first with pressure compensation and secondly without pressure compensation in a sectional view at a distance away from the gaps; and

FIG. 7 shows a perspective view of an embodiment of a piston ring according to the invention in an exploded view (illustrated similarly as in FIGS. 4 through. 6.)

### DETAILED DESCRIPTION OF THE PREFERRED EMBODIMENTS

FIG. 1 shows a twin piston ring according to prior art from GB 1 222 609, for example. The first ring (L-shaped ring) is arranged together with the inserted second ring 2 in the groove 3 of the piston 4. Both split rings 1, 2 can be designed as a single part (with one impact point 5, 6 according to FIG. 7) or they can be designed as two parts—primarily in case of small piston diameters or in case of materials prone to break. The first L-shaped ring 1 is disposed on the pressure side and seals the piston 4 with the inserted second ring 2. The two split rings 1, 2 are secured against twisting by means of a pin or a projection (not illustrated here but known exemplary from cited GB 1 222 609) whereby the gaps are respectively sealed against one another (it is to be noted that in the illustrations in FIGS. 1 through 6, the clearances between the two rings 1, 2 are illustrated largely magnified for the purpose of illustration—just as in the illustration on the right between the two rings 1, 2 and the wall of the groove as well as the illustrated gap between the two rings 1, 2 and the cylinder 7).

Based on the pressure load effective from the pressure side (arrow 12) through the gap 8, 9 and 10, the inserted ring (second ring 2) is generally stressed to a higher degree than the L-shaped ring (first ring 1) and it wears accordingly faster. In addition, the inserted second ring 2 is stressed through extrusion (into the gap 11) at the gap 11 between the piston 4 and the cylinder 7. Based on the nature of this problem, there can always problems be found again with the service life of such known twin piston rings, particularly in the use with small cylinder diameters and light gases.

In the embodiment of FIG. 2, which is known from EP 1 275 888 A1, for example, the inserted second ring 2 engages the groove 14 of an again essentially L-shaped first ring 1 by means of a projection 13 whereby wear is distributed uniformly to the greatest extent to the two rings 1, 2 and a longer service life is thereby achieved. As for the rest, the function of the illustrated piston ring remains essentially the same as the function in FIG. 1.

FIG. 3 shows an already known use of twin piston rings according to FIG. 1 whereby the inserted second ring 2 is disposed on the pressure side (arrow 12) and whereby it no longer seals the impact point 5 of the first ring 1 (through which the sectional view extends in FIG. 3). With this use of the twin piston rings as throttle rings, according to FIG. 1, the desired leakage is developing to make a uniform pressure drop possible through a plurality of such piston rings arranged one behind the other (it is theoretically possible and functionally the same to use twin piston rings according to FIG. 2 as well.) However, the use of this type of construction is sensible only in special cases since leakage through the gaps 5 of the ring 1 is difficult to calculate and since it continuously changes based on continuous wear.

In the inventive embodiment according to FIG. 4, there is now the second ring 2 arranged on the pressure side (arrow 12) of the piston ring whereby the second ring 2 is inserted in the L-shaped cross section of the first ring 1 (according to the embodiment in FIG. 3), and whereby the second ring 2 is provided with a gap 5 at the pressure side (contact area) cooperating with the first ring 1 (through which the sectional view extends again according FIG. 4.) The second ring 2 is also provided with a projection 18 engaging a groove (see reference number 17 in FIG. 7) which is manufactured into the first ring 1 on the inner side (contact area 16) near the axis. The leakage at the gap 5 of the first ring 1 is now sealed in a very simple way (see FIG. 3) and the twin piston ring is sealed in spite of the otherwise simple and classic design (similarly to FIG. 1). The piston ring of the invention operates under a pressure load in such a manner that the L-shaped first ring 1 drags along the second inserted ring 2, which is protected against extrusion in the clearance 11 between the cylinder 7 and the piston 4, whereby both rings 1, 2 wear now uniformly.

Pressure compensation grooves 21 can be provided on the two surfaces 19, 20 between the two rings 1, 2, but preferably on the second ring 2 in this region, to further reduce this uniform wear as illustrated also in FIG. 7. The inserted second ring 2 will be “pressure compensated” through these grooves 21 whereby the L-shaped first ring 1 now drags along the inserted second ring 2 under load whereby, however, the friction and thus its wear is reduced relative to the ring-width ratio.

The twin piston ring according to the invention is additionally illustrated without such pressure compensation: The L-shaped first ring 1 is biased by pressure from the pressure side whereby a friction force develops across the entire axial width of the first ring 1. The first ring 1 and the second ring 2 are equally biased by the forces of friction. Pressure compensation grooves (21 in FIG. 7) are provided now in the region of the contact surfaces 19, 20 according to FIG. 6. The L-shaped first ring 1 is thereby biased by pressure from the pressure side whereby equal pressure develops now in front and behind the inserted second ring 2 via the pressure compensation grooves 21 and whereby the second ring 2 is thus “pressure compensated.” The friction forces and the opposed forces cancel each other across the width of the inserted second ring whereby only the piston ring pressure remains in effect for friction on the L-shaped first ring 1 corresponding to the friction surface-width of said first ring. Considerably reduced wear occurs as a result of reduced friction force on the entire wearing surface after the L-shaped first ring 1 presses against the inserted second ring 2 under the influence of these pressure forces.

According to FIG. 7, essentially radial oriented pressure compensation grooves 23 are arranged on the face 22 of both rings 1, 2 at the pressure side to make the double-action piston ring of the basic embodiment of the invention simple in its effect as desired, especially for higher pressures, whereby the captured pressure is relieved during change in pressure. As illustrated in FIG. 4 only symbolically by dotted lines, there can also be arranged a pressure compensation bore 24 in the region of the projection 18 of the second ring 2 through which irregular wear can be prevented in the region of this projection 18. Pressure compensation reaching almost across the entire circumference of the twin piston ring cannot be continued in this region since a connection between the pressure side and the side to be sealed would be created in the overlapping area. Pressure compensation is therefore not possible in the region of the projection 18 as it is possible at the remaining circumference. Should such a bore 24 now be placed as illustrated in the drawing and be possibly connected to a partial groove 25 at the circumference, then this would result in an approximately 25 percent pressure compensation relative to the total ring width.

1. A piston ring, particularly for a reciprocating piston compressor for specific light gases, consisting of two concentric rings (1, 2) having at least one gap (5, 6) each whereby the first ring (1) has a first arm with an essentially L-shaped cross section extending inwardly in the direction of the axis and a second arm perpendicular thereto extending outwardly, and whereby the second ring (2) has a cross section fitting the missing section in the essentially L-shaped cross section in the form of a rectangular or square recess into which the first ring (1) is inserted opposite of its gap edge(s) (5), which is (are) rotated in circumferential direction or which is (are) disposed opposite the off-set gap edge(s) (6) while sealing the clearance (8, 11) between the piston (4) and the cylinder (7), wherein the second ring (2) is fitted into the L-shaped cross section of the first ring (1) at the pressure side (12) and whereby said second ring (2) is provided with a projection (18) overlapping the associated gap (5) of the first ring (1) at the pressure side (12, 15) as well as the groove (17) manufactured into the first ring (1) at the inner side (16) near the axis.

2. A piston ring according to claim 1, wherein the second ring (2) is provided with pressure compensation grooves (21) on surfaces (19, 20) facing the first ring (1).

3. A piston ring according to claim 1, wherein essentially radial oriented pressure relief grooves (23) are arranged on a face (22) of both rings (1, 2) at the pressure side.

4. A piston ring according to claim 1, wherein a pressure-compensation bore (24) is arranged in the region of the projection (18) of the second ring (2).
